(19) United States
(12) Patent Application Publication
(10) Pub. No.: US 2013/0135082 A1
(43) Pub. Date: May 30, 2013

(54) RFID READING DEVICE AND RFID TAG GRID FOR ASSET MANAGEMENT

(71) Applicants: Tao Xian, Bordentown, NJ (US); Ynjiun Paul Wang, Cupertino, CA (US); Thomas Amundsen, Turnersville, NJ (US)

(72) Inventors: Tao Xian, Bordentown, NJ (US); Ynjiun Paul Wang, Cupertino, CA (US); Thomas Amundsen, Turnersville, NJ (US)

(73) Assignee: Honeywell International, Inc. doing business as (d.b.a.) Honeywell Scanning & Mobility, Fort Mill, SC (US)

(21) Appl. No.: 13/307,632

(22) Filed: Nov. 30, 2011

(51) Int. Cl. G06K 7/01

(52) U.S. Cl. 340/10.1

(57) ABSTRACT

A system and method for asset management that includes receiving from a client, an EIR terminal that includes an optical reading device configured to output the signal and/or results of decodable indicia and has an RFID receiver which outputs a first datum and a second datum. The invention includes locating the decodable indicia within the signal to reveal identifying information about an asset. The first datum identifies one or more of the RFIDs tag in closest proximity to the asset. These RFID tags are affixed to different known locations in a facility; every location within the facility is within the broadcast radius of at least one RFID tag. The second datum identifies at least one RFID tag in closest proximity to the asset.

### FIELD OF INVENTION

The present invention provides a system and method for utilizing both bar code scanning and radio frequency identification (RFID) tracking for cost-effective and enhanced asset management.

### BACKGROUND OF INVENTION

Asset management systems are essential to a variety of industries and assist these industries in tracking concrete items through their life cycle, including creation and disposal.

When managing the assets of a business, there are four types of information about each asset that are essential to tracking that assets. Necessary information includes both information about the present status of the asset as well as historical information regarding the asset. Referred to casually as the Four W′s, these pieces of information answer the following questions about an asset: who, what, where, and when. “Who,” refers to who checked the item most recently and the history of responsible owners. “What,” identifies the asset. “Where,” is the current location of the item and the history of locations. “When,” is when the item was checked most recently and the management history for the item.

Asset management systems employ different technologies in an attempt to track the For W's regarding the assets of a business. Past applications have included marking assets with bar codes, tagging assets with radio frequency identification (RFID) tags, and using global positioning systems (GPS). Each of these approaches has some downfalls that prevent the approach from providing complete asset management information.

The usefulness of bar codes in asset management is limited because although bar codes can be used to track static information about assets, they are less effective at tracking information that is dynamic. Once an item is bar coded, the data available regarding that item is limited to the data encoded in the bar code. Thus, bar codes are useful for identifying the asset (“what”) and when the item was checked (“when”), but information about who checked the item (“who”) and the location of the item (“where”) is harder to track in a bar code because it is constantly changing. Certainly new bar codes can be applied regularly, but without this step, the information in the bar code remains static so at any given time, only the “what” and the “when” of the item will be reliable.

RFID tags are easier to use than bar codes because information can be transmitted from a tag to a receiver or reader from a distance, while bar code scanning requires direct contact with the asset. Despite this enhancement, this technology has shortcoming in asset management as well because like with bar codes, not all desired information is available. Also, the cost of this technology at the enterprise level renders it cost prohibitive in many industries such as retail, healthcare, etc. Additionally, the size of RFID tags render certain smaller items, such as jewelry, difficult to tag.

In asset management systems, RFID tags have been used to identify items (“what”), their location (“where”), and when the items were checked (“when”). However, who is using the item is more complicated. When an item goes through its life cycle at a company and is potentially used by different individuals, that information is not reflected by the RFID affixed to the item. The cost of RFID tagging is prohibitive in environments, such as retail, as the cost of the tag could easily outweigh the cost of the inventory and/or significantly increase overhead, adversely affecting the profit margin.

Asset tracking using GPS is inoperable in indoor environments so it is not useable for many industries. The United Parcel Service uses GPS to track the location of parcels (“where”) and their estimated delivery times (“when”). This technology is useful to the UPS because they operate in an outdoor environment. However, this approach is unrealistic for most businesses, whose assets must be tracked indoors.

A need therefore exists for an efficient and cost-effective way to track a business's assets.

### SUMMARY OF INVENTION

An object of the present invention is to utilize a combination of bar code scanning, RFID tagging, and asset management software to track exemplary information about the assets of a business using a terminal, including but not limited to a mobile device.

Another object of this invention is to provide a RFID infrastructure that is both cost effective and efficient at managing business assets.

An embodiment of the invention comprises: 1) a terminal (e.g., encoded information reading (EIR) terminals configured to read bar codes and/or other types of encoded information) that is configured to read both bar codes and receive RFID information; 2) a computer or a group of computers that are capable of running asset management software and storing asset information; 3) a first set of RFID tags affixed to coordinates in a facility where assets are located; 4) a second set of RFID tags affixed to articles worn by the individuals that interact with the assets; and 5) at least one asset that is marked with a bar code.

The computer that is configured to read both bar codes and receive RFID information can be a single machine or a group of computers networked together. This computer may also be one and the same with the EIR terminal. One of skill in the art will recognize that distributing the necessary processing and storage capabilities may be advantageous depending upon the specific application and the environment in which the invention is being practiced.

The system and method of the present invention utilizes both bar codes and RFID tags to track assets. The assets themselves are coded with bar codes. But rather than affix tags RFID tags to the items, which is often cost-prohibitive and occasionally impossible, RFID tags are affixed to coordinates in the physical facility so that the sphere of transmission of each individual RFID overlaps that of other RFIDs. The location of each asset is therefore discoverable relative to the RFID tags to which it is closest. The pattern in which the RFID tags are affixed to the facility can be referred to as a grid. Additionally, each individual who is potentially interacting with the assets carries and/or wears an item, such as a badge, affixed with an RFID tag.

The EIR terminal is used to scan the bar codes on the assets and to receive information from the RFID tags in the grid and those on the individuals. By scanning the bar codes, the EIR terminal receives information identifying the asset (“what”) and when the item was checked (“when”). Meanwhile, the RFID reader on the EIR terminal gets information regarding the location of the asset by receiving information regarding the proximity of the asset to different tags on the grid (“where”). The RFID reader also receives information about who is operating and/or inspecting each asset from the RFID tags on the individuals (“who”), who are in close proximity to the asset.

Once the EIR terminal has received data identifying the asset (“what”), the time (“when”), the location (“where”), and the individual interacting with the asset (“who”), the EIR terminal can save this information and/or transmit it to a central repository. In one embodiment of the invention, the EIR terminal bundles this data, encrypts it, and then transmits it to another terminal.

Each time asset information is collected, it can be saved to create a historical record. In this manner, the asset is tracked throughout its life cycle.

### BRIEF DESCRIPTION OF DRAWINGS

FIG. 1 depicts a technical architecture of an embodiment of the present invention.

FIG. 2 depicts a component-level layout of an EIR terminal.

FIG. 3 depicts the workflow of an embodiment of the EIR terminal of the present invention.

FIG. 4 depicts a technical architecture of the grid element of an embodiment of the present invention.

### DETAILED DESCRIPTION OF THE INVENTION

The present invention provides a system and method for utilizing both bar code scanning and radio frequency identification (RFID) tracking for cost-effective and enhanced asset management.

An exemplary asset management system will allow a business to track assets throughout their entire life cycle. For example, when tracking IT assets, a single computer may move through a company and be used by many different individuals until it is decommissioned. In order to depreciate this computer and other assets for tax purposes, the company must be able to track this asset throughout its life cycle at the company.

A complete asset management system is one that can track the following information: 1) the nature of the asset (“what); 2) the current and past locations of the asset (“where”); 3) the most recent time that the asset was checked (“when”); 4) the individual currently interacting with the asset as well as the individual who have historically interacted with the asset (“who”).

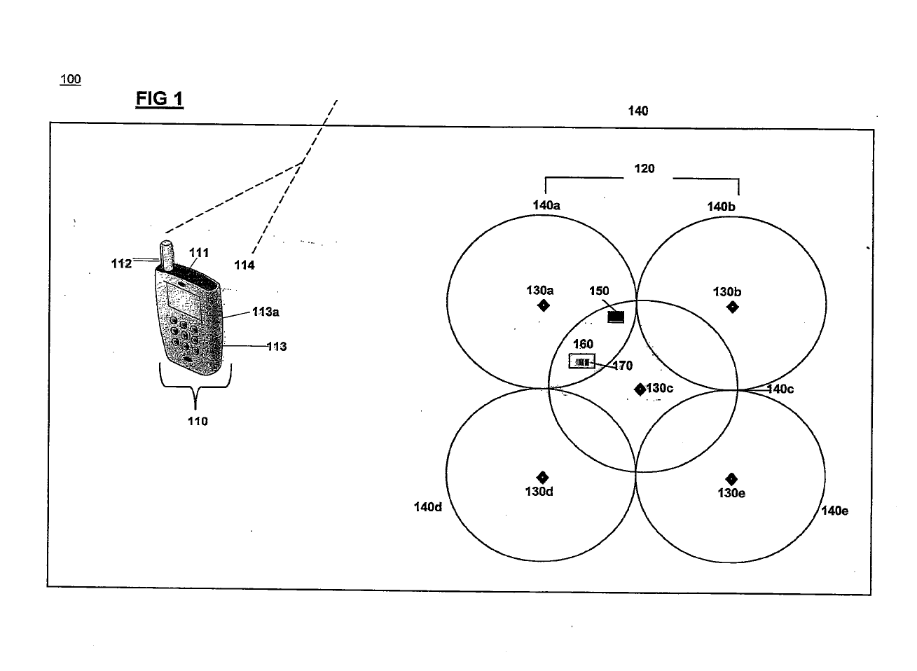

Referring to FIG. 1, the technical architecture 100 of an embodiment used to practice the method of the invention includes the following elements: 1) at least one asset 160 that is marked with a bar code 170; 2) an EIR terminal 110; 3) an RFID tag grid 120; and 4) at least one RFID tag affixed to an item worn by an individual 150.

This EIR terminal 110 includes but is not limited to a mobile device, such as a smart phone or a laptop. This EIR terminal 110 contains a bar code scanner 111 as well as an RFID reader 112 which may be integrated into the same device or be separate devices internal and/or external to the EIR terminal 110. The term bar code also refers to any item containing decodable indicia, including but not limited to a 1D bar code, a 2D bar code and/or one or more optical character recognition (OCR) symbols. Additionally, the bar code scanner 111 includes any device that can be used to capture an signal of the item, the signal refers to but not limited to the an image of the item, signal from optoelectronic conversion device such as photodiode; the devices include but not limited to laser scanners and/or using a camera to capture an image of the item.

In this embodiment, the EIR terminal also includes a CPU 113 that is capable of running software supporting the method and a storage device 113a that is capable of storing information collected by the EIR terminal 110. This architecture is offered as an example and the processing and storage capabilities may be off-loaded and distributed over other processors and databases on a communications network.

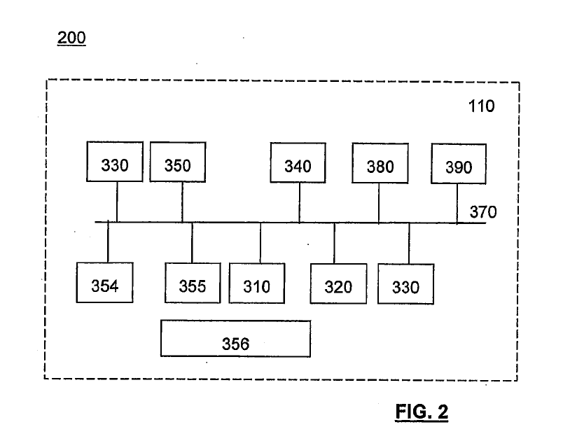

In an embodiment of the present invention, the EIR terminal 110 also includes a wireless module 114 or network connection with which to communicate with one or more additional terminals. Additionally, the EIR terminal 110 is capable of encrypting information received by the bar code scanner 111 and the RFID reader 112. Once the EIR terminal 110 encrypts data, it can transmit the data via the wireless module 114. FIG. 2, which is described later, is a component-level layout of an embodiment of EIR terminal 110.

Encryption of data is particularly advantageous when the asset data is being send from one physical destination to another across a network. The assets that a business has under management is information that would be particularly useful to individuals seeking steal the assets. Therefore, this step is helpful for the security of the business.

Asset 160 is located within a physical facility 140. This asset 160 is marked with a bar code 170. The bar code scanner 111 of the EIR terminal 110 is employed to scan the bar code 170. By scanning the bar code 170 with the bar code scanner 111, the EIR terminal 110 receives information about the asset that was encoded in the bar code 170. Information encoded in the bar code includes but is not limited to asset identification information (“who”) and the time that the asset was checked (“when”).

As seen in FIG. 1, rather than affix RFID tags to the asset 160, which as aforementioned is cost prohibitive and not always possible, RFID tags are affixed to coordinates in the physical facility 140 that houses the asset 160. Thus, this system and method takes advantage of the RFID technology in a manner that is not limited by the assets being tracked.

The location of asset 160 is the physical facility 140 is in a physical area where a number of RFID tags 130a-130e are affixed in a pattern, e.g. an RFID tag grid 120. In the grid configuration in FIG. 1, the zones of transmission and the radii of the RFID tags 140a-140e overlap each other so that a given location on the grid 120 may be within the zone of transmission of more than one RFID tag.

The configuration of the grid in FIG. 1 is one example. One of ordinary skill in the art will appreciate that provided at least one tag is within the range of the RFID reader when a tag is read, the asset is assigned an approximate location. Multiple tags can be used to improve the confidence and/or accuracy of the location. Factors such as the physical attributes of the location of the assets and the type of assets influence what configuration of tags will best generate a useable location data.

From any location in the physical facility 140, the RFID reader 112 on the EIR terminal 110 transmits an encoded radio signal and interrogates the tags 130a-130e. The tags 130a-130e receive the signal and those within the range of the RFID reader 112, respond with identification information. Thus, if the EIR terminal 110 is placed near the asset 160 on the RFID tag grid 120, the RFID reader 112 on the EIR terminal 110 will be able to read more than one of the tags on the RFID tag grid 120 at a given time. By interrogating the tags in close proximity to the asset 160, the RFID reader 112 receives information about the location of the asset 160 (“where”). FIG. 4, which is described later, is a more detailed diagram of an RFID tag grid 120 that can be utilized in this embodiment of the present invention.

Each Individual 180 within the facility who interacts with the asset 160 that is being tracked and managed in this embodiment wears and/or carries an item, such as a badge, that is affixed with an RFID tag 150. The RFID reader 112 on the EIR terminal 110 transmits an encoded radio signal to interrogate the wearable RFID tag 150. In response, the wearable RFID tag 150 transmits information identifying the individual back to the RFID reader 112. By interrogating a wearable RFID tag 150 that is in close proximity to the asset 160, the RFID reader 112 receives identification information regarding the individual interacting with the asset (“who”).

Component-level diagram of one embodiment of an EIR terminal is now being described with references to FIG. 2. EIR terminal 110 can comprise at least one microprocessor 310 and a memory 320, both coupled to the system bus 370. The microprocessor 310 can be provided by a general purpose microprocessor or by a specialized microprocessor (e.g., an ASIC). In one embodiment, EIR terminal 110 can comprise a single microprocessor which can be referred to as a central processing unit (CPU). In another embodiment, EIR terminal 110 can comprise two or more microprocessors, for example, a CPU providing some or most of the EIR terminal functionality and a specialized microprocessor performing some specific functionality. A skilled artisan would appreciate the fact that other schemes of processing tasks distribution among two or more microprocessors are within the scope of this disclosure.

EIR terminal 110 can further comprise a communication interface 340 communicatively coupled to the system bus 370. In one embodiment, for example, the embodiment of FIG. 1, the communication interface can be provided by a wireless communication interface. The wireless communication interface can be configured to support, for example, but not limited to, the following protocols: at least one protocol of the IEEE 802.11/802.15/802.16 protocol family, at least one protocol of the HSPA/GSM/GPRS/EDGE protocol family, TDMA protocol, UMTS protocol, LTE protocol, and/or at least one protocol of the CDMA/1×EV-DO protocol family.

EIR terminal 110 can further comprise a keyboard interface 354 and a display adapter 355, both also coupled to the system bus 370. EIR terminal 100 can further comprise a battery 356. In one embodiment, the battery 356 can be provided by a replaceable rechargeable battery pack.

EIR terminal 110 can further comprise a GPS receiver 380. EIR terminal 110 can further comprise at least one connector 390 configured to receive a subscriber identity module (SIM) card.

EIR terminal 110 can further comprise one or more EIR devices 330, provided, for example, but not limited to, by an RFID reading device, a bar code reading device, or a card reading device. In one embodiment, the RFID terminal can be configured to read an encoded message using EIR device 330, and to output raw message data containing the encoded message. In another embodiment, the RFID terminal can be configured to read an encoded message using EIR device 330, and to output decoded message data corresponding to the encoded message. As used herein, “message” is intended to denote a character string comprising alphanumeric and/or non-alphanumeric characters. An encoded message can be used to convey information, such as identification of the source and the model of a product, for example, in a UPC code.

Of course, devices that read bar codes, read RFID, or read cards bearing encoded information may read more than one of these categories while remaining within the scope of this disclosure. For example, a device that reads bar codes may include a card reader, and/or RFID reader; a device that reads RFID may also be able to read bar codes and/or cards; and a device that reads cards may be able to also read bar codes and/or RFID. For further clarity, it is not necessary that a device's primary function involve any of these functions in order to be considered such a device; for example, a cellular telephone, smart phone, or PDA that is capable of reading bar codes is a device that read bar codes for purposes of this disclosure.

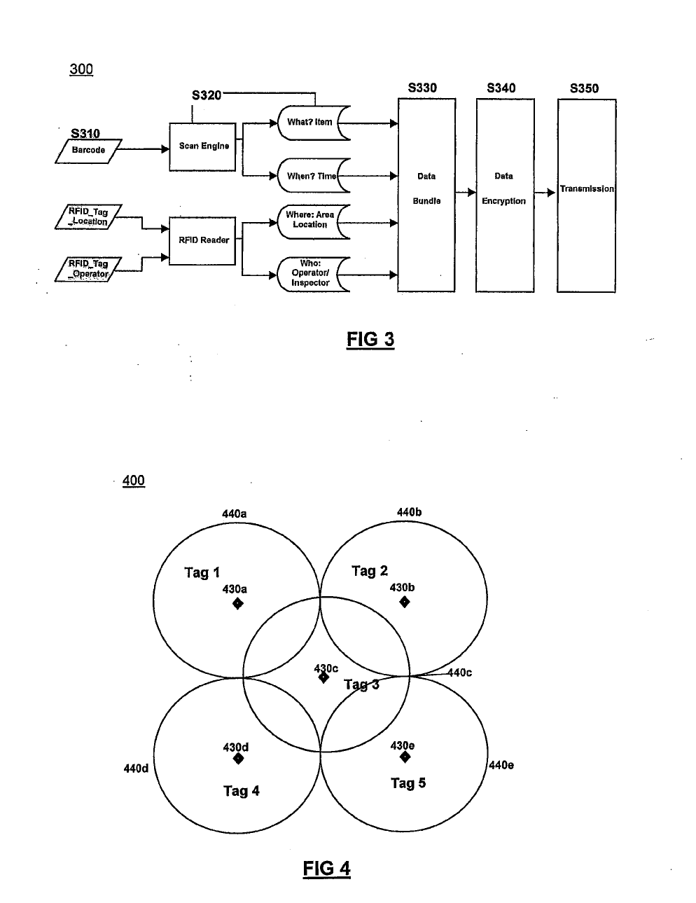

The workflow of an embodiment of the EIR terminal in the present invention is represented in FIG. 3. For ease, the descriptions of this workflow reference, where appropriate, elements of the technical architecture of the embodiment in FIG. 1. The references to the elements are for descriptive reasons only, are not limiting, and many other variations and modifications will become apparent to those skilled in the art.

Referring to the workflow 300 of FIG. 3, the asset information is available to the EIR terminal 110 (S310). The sources of this information include: 1) the bar code on the asset 170, 2) the RFID tags in the RFID tag grid 120 in the physical location of the asset 160, and 3) the wearable RFID tag 150 of the individual interacting with the asset 160. The EIR terminal then collects the asset information (S320) from the bar code on the asset 170, via the bar code scanner 111, and from the RFID tags in the RFID tag grid 120 and the wearable RFID tag 150, via the RFID reader 112. The decoded bar code data identifies the asset (“what”) and when the asset was checked (“when”). One or more tags on the RFID grid 120 identify the location of the asset (“where”). The wearable RFID tag 150 identifies who is interacting (e.g., managing, operating, inspecting) the asset 160. After the EIR terminal collects this information, it bundles the data from the varied sources together (S330). Once the asset management data set is complete, the EIR terminal bundles the data (S340) and transmits this information (S350) to another terminal, including but not limited to a central repository via a wireless connection 114.

In another embodiment of the present invention, the EIR terminal can save the collected information regarding the asset locally, adding new data to the data from previous asset checks. In this manner, a historical record of the asset is created and the asset is tracked throughout its life cycle.

FIG. 4 is a detailed depiction of an embodiment of RFID tag grid 120. In the grid 400 of FIG. 4, the RFID tags 430a-430e that are affixed to locations so that the zones to which each tag 440a-440e can broadcast overlap each other. When an asset is located anywhere on the grid, the EIR terminal, when in proximity to this asset, queries the RFID tags 430a-430e and based upon the tags within range, receive information regarding the location of the asset. The distance of the tags 430a-430e in the grid 400 from the reader can be adjusted according to the range of the reader and the accuracy required. The accuracy of the location available from querying the grid 400 is based upon the density of the tags in the grid.

The density of the tags affects the specificity of the location data. For example, if the range of each tag in the grid of FIG. 4 or an alternate configuration of the grid is 10 meters, then the location of an asset within the facility will always be known within 10 meters. In order to make the measurement more specific, the density of the tags within the grid is increased.

A number of additional approaches can be used to enhance the specificity of locations as provided by the RFID tag. The approaches are described herein are not limiting and many other variations and modifications will become apparent to those skilled in the art. These approaches will be discussed in reference to the embodiment of the present invention in FIG. 1.

Varying the power level of the RFID tag reader 112 can enhance the location information obtained from tag grid 120. To practice this approach, the RFID tag reader 112 is initially set to the maximum power level such that it detects all RFID tags within its range. The power level is then reduced incrementally and each time, the tags within range are queried and read. This is repeated until a minimum power level is established wherein tags are still within range and can be read by the RFID tag reader 112. The RFID tag reader 112 and/or the application employed can differentiate between the different radii induced by the different power levels. The RFID tag reader 112 and/or associated application can determine the approximate location of the tags. Thus, the location of the asset 160 on the grid 120 is determined relative to the approximate location of the tags.

The strength of the signal received from the RFID tags in the RFID tag grid 120 by the RFID tag reader 112 can also be used to determine the location of an asset 160. By using the received signal strength, the reader 112 can estimate the distance between the tag and the reader 112 at the location of the asset 160.

The RFID tag reader 112 can also employ triangulation, i.e. reference the angle of arrival of the RFID tags' transmissions, to determine the location of an asset. Triangulation is the process of finding the coordinates and the distance to a point by calculating the length of one side of the triangle, which is formed by that point and two other known reference points, based on the measurements of the angles and other triangle sides. In the technique, the RFID reader 112, i.e. the antenna, measures the angle of incoming and outgoing signals to and from the RFID tags 130a-130e.

Although the present invention has been described in relation to particular embodiments thereof, many other variations and modifications will become apparent to those skilled in the art. As such, it will be readily evident to one of skill in the art based on the detailed description of the presently preferred embodiment of the system and method explained herein, that different embodiments can be realized.

1. A computer system for asset management, the computer system comprising:
one or more processors, one or more computer-readable memories and one or more computer-readable, tangible storage devices;
program instructions, stored on at least one of the one or more storage devices for execution by at least one of the one or more processors via at least one of the one or more memories, to receive an signal of decodable indicia from a client
wherein said decodable indicia appear on an asset and
wherein said client is provided by an encoded information reading (EIR) terminal comprising an optical reading device configured to output said signal of decodable indicia and an RFID receiver configured to output a first datum and a second datum;
program instructions, stored on at least one of the one or more storage devices for execution by at least one of the one or more processors via at least one of the one or more memories, to, responsive to receiving said signal of decodable indicia from said client, locate said decodable indicia within said signal;
program instructions, stored on at least one of the one or more storage devices for execution by at least one of the one or more processors via at least one of the one or more memories, to, responsive to locating said decodable indicia within said signal, decode said decodable indicia into a decoded message
wherein said decoded message contains at least one of: identifying information about said asset and a timestamp;
program instructions, stored on at least one of the one or more storage devices for execution by at least one of the one or more processors via at least one of the one or more memories, to receive a first datum from said client
wherein said first datum identifies at least one RFID tag from a first plurality of RFID tags
wherein said at least one RFID tag is in closest proximity to said asset and
wherein each of said first plurality of RFID tags is affixed to a different known location in a facility so that every location within said facility is within the broadcast radius of at least one of said plurality of RFID tags; and
program instructions, stored on at least one of the one or more storage devices for execution by at least one of the one or more processors via at least one of the one or more memories, to receive a second datum from said client
wherein said second datum identifies at least one RFID tag in closest proximity to said asset from a second plurality of RFID tags and
wherein each of said second plurality of RFID tags is affixed to a different person in said facility.

2. The computer system of claim 1, wherein a first radius of transmission of a first tag of said first plurality of RFID tags overlaps a second radius of transmission of a second of said first plurality of RFID tags.

3. The computer system of claim 1, further comprising
program instructions, stored on at least one of the one or more storage devices for execution by at least one of the one or more processors via at least one of the one or more memories, to encrypt said decoded message said first datum, and said second datum.

4. The computer system of claim 1, further comprising
program instructions, stored on at least one of the one or more storage devices for execution by at least one of the one or more processors via at least one of the one or more memories, to save said decoded message said first datum, and said second datum.

5. The computer system of claim 1, further comprising
program instructions, stored on at least one of the one or more storage devices for execution by at least one of the one or more processors via at least one of the one or more memories, to encrypt said decoded message said first datum, and said second datum; and
program instructions, stored on at least one of the one or more storage devices for execution by at least one of the one or more processors via at least one of the one or more memories, to transmit said encrypted decoded message said encrypted first datum, and encrypted said second datum to an external accounting system.

6. A method for asset management, the method comprising the steps of:
a computer receiving a signal of decodable indicia from a client
wherein said decodable indicia appear on an asset and
wherein said client is provided by an encoded information reading (EIR) terminal comprising an optical reading device configured to output said signal of decodable indicia and an RFID receiver configured to output a first datum and a second datum;
said computer, responsive to receiving said signal of decodable indicia from said client, locating said decodable indicia within said signal;
said computer, responsive to locating said decodable indicia within said signal, decoding said decodable indicia into a decoded message
wherein said decoded message contains at least one of: identifying information about said asset and a timestamp;
said computer receiving a first datum from said client
wherein said first datum identifies at least one RFID tag from a first plurality of RFID tags
wherein said at least one RFID tag is in closest proximity to said asset and
wherein each of said first plurality of RFID tags is affixed to a different known location in a facility so that every location within said facility is within the broadcast radius of at least one of said plurality of RFID tags; and
said computer receiving a second datum from said client
wherein said second datum identifies at least one RFID tag in closest proximity to said asset from a second plurality of RFID tags and
wherein each of said send plurality of RFID tags is affixed to a different person in said facility.

7. The method of claim 6, wherein a first radius of transmission of a first tag of said first plurality of RFID tags overlaps a second radius of transmission of a second of said first plurality of RFID tags.

8. The method of claim 6, further comprising
said computer encrypting said decoded message said first datum, and said second datum.

9. The method of claim 6, further comprising
said computer saving said decoded message said first datum, and said second datum.

10. The method of claim 6, further comprising
said computer encrypting said decoded message said first datum, and said second datum; and
said computer transmitting said encrypted decoded message said encrypted first datum, and encrypted said second datum to an external accounting system.

11. A computer program product for managing business assets, the computer program product comprising:
one or more computer-readable tangible storage devices;
program instructions, stored on at least one of the one or more storage devices, to receive an signal of decodable indicia from a client
wherein said decodable indicia appear on an asset and
wherein said client is provided by an encoded information reading (EIR) terminal comprising an optical reading device configured to output said signal of decodable indicia and an RFID receiver configured to output a first datum and a second datum;
program instructions, stored on at least one of the one or more storage devices, to, responsive to receiving said signal of decodable indicia from said client, locate said decodable indicia within said signal;
program instructions, stored on at least one of the one or more storage devices, to, responsive to locating said decodable indicia within said signal, decode said decodable indicia into a decoded message
wherein said decoded message contains at least one of: identifying information about said asset and a timestamp;
program instructions, stored on at least one of the one or more storage devices, to receive a first datum from said client
wherein said first datum identifies at least one RFID tag from a first plurality of RFID tags
wherein said at least one RFID tag is in closest proximity to said asset and
wherein each of said first plurality of RFID tags is affixed to a different known location in a facility so that every location within said facility is within the broadcast radius of at least one of said plurality of RFID tags; and
program instructions, stored on at least one of the one or more storage devices, to receive a second datum from said client
wherein said second datum identifies at least one RFID tag in closest proximity to said asset from a second plurality of RFID tags and
wherein each of said send plurality of RFID tags is affixed to a different person in said facility.

12. The computer program product of claim 11, wherein a first radius of transmission of a first tag of said first plurality of RFID tags overlaps a second radius of transmission of a second of said first plurality of RFID tags.

13. The computer program product of claim 11, further comprising
program instructions, stored on at least one of the one or more storage devices, to encrypt said decoded message said first datum, and said second datum.

14. computer program product of claim 11, further comprising
program instructions, stored on at least one of the one or more storage devices, to save said decoded message said first datum, and said second datum.

15. computer program product of claim 11, further comprising
program instructions, stored on at least one of the one or more storage devices, to encrypt said decoded message said first datum, and said second datum; and
program instructions, stored on at least one of the one or more storage devices, to transmit said encrypted decoded message said encrypted first datum, and encrypted said second datum to an external accounting system.

16. A computer system for asset management, the computer system comprising:
one or more processors, one or more computer-readable memories and one or more computer-readable, tangible storage devices;
program instructions, stored on at least one of the one or more storage devices for execution by at least one of the one or more processors via at least one of the one or more memories, to receive data from a client
wherein said client comprises an RFID receiver configured to output data
wherein said data identifies at least one RFID tag from a plurality of RFID tags
wherein said at least one RFID tag is in closest proximity to an asset in a facility and
wherein each of said plurality of RFID tags is affixed to a different known location in said facility so that every location within said facility is within the broadcast radius of at least one of said plurality of RFID tags.

17. The computer system of claim 16, wherein a first radius of transmission of a first tag of said first plurality of RFID tags overlaps a second radius of transmission of a second of said first plurality of RFID tags.

18. The computer system of claim 16, further comprising:
program instructions, stored on at least one of the one or more storage devices for execution by at least one of the one or more processors via at least one of the one or more memories, to encrypt said data.

19. The computer system of claim 16, further comprising:
program instructions, stored on at least one of the one or more storage devices for execution by at least one of the one or more processors via at least one of the one or more memories, to save said data.

20. The computer system of claim 16, further comprising
program instructions, stored on at least one of the one or more storage devices for execution by at least one of the one or more processors via at least one of the one or more memories, to encrypt said data; and
program instructions, stored on at least one of the one or more storage devices for execution by at least one of the one or more processors via at least one of the one or more memories, to transmit said encrypted data to an external accounting system.
